(19) United States
(12) Patent Application Publication
(10) Pub. No.: US 2022/0397425 A1
(43) Pub. Date: Dec. 15, 2022

(54) DENOISING APPARATUS, DENOISING METHOD, AND UNMANNED AERIAL VEHICLE

(71) Applicant: Sony Group Corporation, Tokyo (JP)

(72) Inventors: Gabriel ARMELIN, Stuttgart (DE); Olivier DEMARTO, Stuttgart (DE)

(73) Assignee: Sony Group Corporation, Tokyo (JP)

(21) Appl. No.: 17/770,047

(22) PCT Filed: Oct. 28, 2020
(86) PCT No.: PCT/EP2020/080230

§ 371 Date: Apr. 19, 2022

(30) Foreign Application Priority Data
Nov. 7, 2019 (EP) 19207625.5

(51) Int. Cl. G01D 3/08; B64C 39/02; B64D 45/00

(52) U.S. Cl. CPC G01D 3/08; B64C 39/024; B64D 45/00

(57) ABSTRACT

A denoising apparatus, including a Micro-Electro-Mechanical System, MEMS, sensor circuit, which is configured to generate a measurement signal in response to a physical quantity. The measurement signal includes a useful signal component indicative of the physical quantity and an attack signal component due to an attack on the MEMS sensor circuit. The denoising apparatus further includes a machine learning circuitry, which is configured to estimate the useful signal component based on the measurement signal. The machine learning circuitry is trained based on training signals comprising known useful signal components and known attack signal components.

### FIELD

The present disclosure relates to a denoising apparatus, a denoising method, and an unmanned aerial vehicle.

### BACKGROUND

Cyber-physical systems (CPS) depend on sensors to make automated decisions. Micro-Electro-Mechanical Systems (MEMS) sensors can be used as key pieces to build CPS. In these systems, physical and software components can be deeply intertwined to create smart grid, autonomous auto mobility systems, medical monitoring, process control systems, robot systems, or automatic pilot avionics.

The MEMS technology combines mechanical and electrical components at the microscale range. MEMS sensors are widely used due to their small size, low cost, and low power consumption. They can be used to measure different parameters such as: chemical concentration, acceleration, pressure, humidity, etc.

Due the wide use of MEMS sensors, they have become a new target for attacks, for example sound attacks. In this context, sound attacks are attacks in which an attacker injects malicious signals into the system by using vulnerabilities in the sensor devices. An important characteristic of MEMS sensors is the response to resonant frequencies of their mechanical components. These frequencies have been identified as a problem that can cause the performance degradation of some MEMS sensors, and thus they are often considered to be commercial secrets or are designed to be just higher than the audible frequency range to avoid or mitigate influences of audible frequency on sensor's readings.

In the worst case, attacks injecting malicious signals could cause car accidents, airplane crashes or any other types of accidents that could happen to a vehicle or a device using MEMS sensors.

Therefore, the security aspect may be of high importance for these sensor devices in order to make their manipulation more difficult.

Hence, there is a need for a method to reduce the vulnerability of a MEMS sensor.

### SUMMARY

This demand is addressed by the subject-matter of the independent claims. Further useful embodiments are addressed by the dependent claims.

According to a first aspect of the present disclosure, it is provided a denoising apparatus, comprising a MEMS sensor circuit being configured to generate a measurement signal in response to a physical quantity, wherein the measurement signal comprises a useful signal component indicative of the physical quantity and an attack signal component due to an attack on the MEMS sensor circuit. The denoising apparatus further comprises a machine learning circuitry being configured to estimate the useful signal component based on the measurement signal, the machine learning circuitry being trained based on training signals comprising known useful signal components and known attack signal components.

The MEMS sensor circuit may generate a measurement signal being influenced by an attack. Due to resonant frequencies accompanying the attack, the MEMS sensor may start vibrating which may result in a noisy measurement signal generated by the MEMS sensor circuit. The noisy measurement signal comprises an original signal or a useful signal component indicative of a physical quantity and a disturbing attack signal component. The useful signal may comprise information for controlling a device or vehicle in response to the measured physical quantity.

In order to prevent manipulations of a MEMS sensor's signal, the attack signal is removed from the noisy measurement signal by the machine learning circuitry. In this way, only the useful signal may be forwarded, and a manipulation of the measurement signal generated by the MEMS sensor circuit may be successfully avoided.

In some embodiments, the attack signal component comprises one or more signals generated by the MEMS sensor circuit in response to stimulating the MEMS sensor circuit with one or more stimuli at the MEMS sensor circuit's resonant frequency. As described above, one example of such a stimulus is a sound signal having frequency components at one or more resonant frequencies of mechanical components of the MEMS sensor circuit. Thus, the attack signal component may result from a sound attack. The attack may be a sound attack.

In some embodiments, the MEMS sensor circuit comprises at least one of a gyroscope circuit and an accelerometer circuit. The attacks may cause a malicious acceleration of a device or vehicle in case of an accelerometer. In case of a gyroscope, the attack may cause a malicious angular velocity of a device or vehicle.

In some embodiments, the machine learning circuitry comprises a neural network. Artificial neural networks can “learn” to perform tasks by considering examples, generally without being programmed with task-specific rules. For example, they can learn to identify measurement signals that contain attack signals by analyzing example measurement signals that have been manually labeled in the sense of “containing attack signal” or “not containing attack signal” and using the results to identify attack signals in other measurement signals. By use of a neural network, the machine learning circuitry may provide a training of an algorithm or model function in order to obtain an estimated output, in particular, an estimated useful signal, which may be useful for controlling a vehicle or device with the MEMS sensor.

In some embodiments, the neural network comprises a recurrent neural network or a recurrent denoising autoencoder.

A recurrent neural network (RNN) is a class of artificial neural networks where connections between nodes form a directed graph along a temporal sequence. This allows it to exhibit temporal dynamic behavior. Unlike feedforward neural networks, RNNs can use their internal state (memory) to process sequences of inputs.

Using a recurrent neural network, a problem of high correlation between the measurement signal generated by the MEMS sensor circuit and the attack signal can be addressed. The recurrent neural network is capable to separate them by including the time dimension.

Recurrent neural networks may learn a mapping function for the inputs over time to an output. This means that the outputs may be conditional on a recent context in the input sequence instead of only the current sequence itself. This characteristic may allow to better separate signals correlated in time domain, which may be the case for the noisy measurement signal generated by the MEMS sensor circuit and the useful signal component thereof.

A recurrent denoising autoencoder is a special type of autoencoder. An autoencoder is an encoder-decoder neural network that learns to copy its input to its output. It has an internal (hidden) layer that describes a code used to represent the input, and it is constituted by two main parts: an encoder that maps the input into the code, and a decoder that maps the code to a reconstruction of the original input. Denoising autoencoders (DAEs) take a partially corrupted input and are trained to recover the original undistorted input. In practice, the objective of denoising autoencoders is that of cleaning the corrupted input, or denoising. Recurrent denoising autoencoders can summarize sequential data through an encoder structure into a fixed-length vector and then reconstruct into its original sequential form through the decoder structure. The summarized information can be used to represent time series features.

Recurrent Denoising Autoencoders may enable removing the attack signal component from the noisy measurement signal generated by the MEMS sensor circuit. The training of a corresponding algorithm or model function may comprise learning the useful signal component of the noisy measurement signal generated by the MEMS sensor circuit. The neural network may output a predicted useful signal component. Therefore, to train the model function, it may be necessary to provide the noisy measurement signal generated by the MEMS sensor circuit as features of the model function, and the useful signal component as the target signal to be estimated by the training process.

In another example of the denoising apparatus, the neural network comprises a Long Short-Term Memory, LSTM, recurrent neural network or a Gated Recurrent Unit, GRU, recurrent neural network.

Long short-term memory (LSTM) is an RNN architecture used in the field of deep learning. Unlike standard feedforward neural networks, LSTM has feedback connections. It may not only process single data points (such as images), but also entire sequences of data (such as speech or video). For example, LSTM is applicable to tasks such as speech recognition. LSTM networks are well-suited to classifying, processing and making predictions based on time series data, since there can be lags of unknown duration between important events in a time series.

Gated recurrent units (GRUs) are a gating mechanism in recurrent neural networks. The GRU is like a long short-term memory (LSTM) with forget gate but has fewer parameters than LSTM, as it lacks an output gate. The GRU's performance on certain tasks of, for example, speech signal modeling is similar to that of LSTM.

The different types of recurrent neural networks may also allow to better separate signals correlated in time domain. Such a correlation in the time domain may occur for the noisy measurement signal of the MEMS sensor circuit and the useful signal component thereof.

In some embodiments, the neural network comprises, as already described, an encoder portion and a decoder portion. The encoder portion comprises an input layer for receiving the measurement signal and a set of hidden layers for compressing the input data to low dimensional data. The decoder portion comprises a set of hidden layers for reconstructing the compressed low dimensional data and an output layer for outputting the estimated useful signal component. Each single layer comprises a matrix comprising a plurality of weights being a basis for compressing the input data in the encoder portion and reconstructing the compressed data in the decoder portion. The set of hidden layers of each the encoder portion and the decoder portion comprise multiple hidden layers, forming a deep recurrent neural network or a Deep Recurrent Denoising Autoencoder (DRDAE).

By use of a deep Recurrent Denoising Autoencoder, the attack signal component may be removed from the noisy measurement signal generated by the MEMS sensor circuit more accurately, compared to the use of a Recurrent Denoising Autoencoder, due to the multiple hidden layers in the neural network. The multiple hidden layers may increase the degree of freedom of the learnt model function and may allow model functions to learn different types of nonlinear signals, and thus may lead to an increased accuracy of an estimation of a useful signal.

In some embodiments, the denoising apparatus is further configured to forward the estimated useful signal component as a control signal for controlling one or more devices. Ideally, the estimated useful signal component corresponds to the original useful MEMS sensor signal component. Some examples of devices to be controlled are ground vehicles (e.g. cars) or aerial vehicles (e.g. planes).

According to a further aspect of the present disclosure, it is provided an unmanned aerial vehicle comprising an embodiment of the denoising apparatus.

The unmanned aerial vehicle comprising a denoising apparatus may be well protected against attacks and potential manipulations of the MEMS sensor circuits. In this way, accidents may be successfully avoided.

According to a further aspect of the present disclosure, it is provided a denoising method. The method comprises generating, by a MEMS sensor circuit, a measurement signal in response to a physical quantity. The measurement signal comprises a useful signal component indicative of the physical quantity and an attack signal component due to an attack on the MEMS sensor circuit. The denoising method further comprises estimating, by a machine learning circuitry, the useful signal component based on the measurement signal, the machine learning circuitry being trained based on training signals comprising known useful signal components and known attack signal components.

As a further example, an apparatus comprises a MEMS sensor circuit, configured to generate a measurement signal in response to a physical quantity. The measurement signal comprises a useful signal component indicative of the physical quantity and an attack signal component due to an attack on the MEMS sensor circuit. The apparatus further comprises a digital signal processor, configured to estimate the useful signal component by eliminating the attack signal component from the measurement signal.

### BRIEF DESCRIPTION OF THE FIGURES

Some examples of apparatuses and/or methods will be described in the following by way of example only, and with reference to the accompanying figures, in which

FIG. 1 illustrates schematic drawings of a) a MEMS sensor, b) a MEMS sensor being influenced by a resonant frequency, and c) a MEMS sensor being attacked by a sound (spoof) attack;

FIG. 2 shows a) schematic illustration of denoising the noisy measurement signal of the MEMS sensor being attacked by a sound (spoof) attack by use of a machine learning circuitry and b) a block diagram illustrating a denoising apparatus;

FIG. 3 illustrates a schematic drawing showing the principle of an Autoencoder Neural Network in a) a simple way and in b) a more detailed way;

FIG. 4 schematically illustrates application scenarios for drones in (a) a normal operational scenario, (b) an attacker scenario and (c) a protected scenario; and

FIG. 5 shows a flow chart illustrating a denoising method.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

The Micro-Electro-Mechanical Systems (MEMS) technology is one of the main technologies to fabricate sensors and it combines mechanical and electrical systems at the microscale range. MEMS sensors are being widely used due to their small size, low cost and low power consumption, and they can measure different parameters like, for example, chemical concentration, acceleration, pressure or humidity.

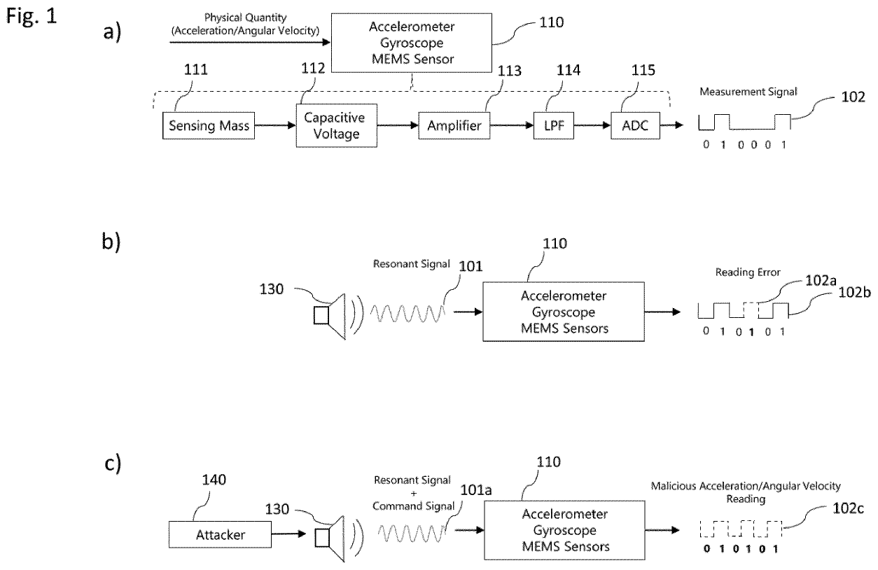

There is a limited number of transduction mechanisms being compatible with the operational scale of MEMS sensors. The most common transduction mechanisms are: piezoresistive, capacitive, piezoelectric and inductive. They usually convert mechanical energy into electrical energy. The process for MEMS sensors comprising a capacitive transducer is shown in FIG. 1 a).

FIG. 1 a) illustrates a MEMS sensor 110 measuring a physical quantity like, for example, an acceleration or angular velocity of a device or a vehicle. The MEMS sensor 110 comprises a sensing mass 111. This sensing mass 111 is moved or displaced based on the physical quantity acting upon the sensing mass 111. The movement or displacement of the sensing mass 111 causes a capacitive structure thereof to output a certain capacitive voltage 112. This capacitive voltage 112 is amplified by an amplifier 113. The amplified voltage is passed through a low-pass filter (LPF) 114. The LPF 114 passes signals with a frequency lower than a selected cutoff frequency and attenuates signals with frequencies higher than the cutoff frequency. Finally, the low-pass filtered voltage is converted to a binary signal via an analog-to-digital converter 115 in order to output a (binary) measurement signal 102 of the MEMS sensor 110.

An important characteristic of MEMS sensors is the response to their resonant frequencies. All physical objects have a resonant frequency (natural frequency) or frequencies in which they react with a vibration. These frequencies depend on both the mass and rigidity of the object. The resonant frequencies of MEMS sensors have been identified as a problem that could cause a performance degradation of some MEMS sensors, and thus they are often considered to be commercial secrets or are designed to be just higher than the audible frequency range to avoid or mitigate influences of audible frequency on sensors' readings. However, MEMS sensors influenced by a resonant signal may cause a reading error in the output measurement signal, as shown in FIG. 1 b).

Ideally, a measurement signal of a MEMS sensor, like e.g. accelerometers and gyroscopes, is a clean measurement signal generated in response to the physical quantity without any external influences. This signal represents the measured physical quantity and can therefore be regarded as a useful signal for further controlling of devices or vehicles using such MEMS sensors.

MEMS sensors can start vibrating in case of a sound (spoof) attack, in which a resonant signal 101 at the MEMS' resonant frequency is output by a sound source 130, as illustrated in FIG. 1 b). A resulting mechanical vibration of the MEMS sensor 110 leads to a noisy measurement signal comprising an attack signal component 102a causing a reading error. Thus, the noisy measurement signal generated by the attacked MEMS sensor 110 comprises a superposition of a useful signal component 102b indicative of the measured physical quantity and an attack signal component 102a causing the reading error in the measurement signal.

In FIG. 1 c), a scenario is illustrated where an attacker 140 causes an attack signal 101a via sound source 130. Causing an attack is not limited to resonant sound signals or sound waves being in the frequency range of the resonant frequency of the MEMS sensor. Alternatively, an attack may also be caused by mechanical vibrations having the same resonant frequency as the MEMS sensor. The mechanical resonant vibrations may cause the same disturbing effects like the resonant sound signals. These mechanical vibrations may be caused by environmental influences like a vibrating ground or wind. A skilled person having benefit from the present disclosure will appreciate that also another signal with identical or similar signal characteristics may have the same effect on the MEMS sensor as an attack signal although the other signal has been accidentally generated, generated from any other device for another purpose or environmental influences. In case of an attack, the attack signal 101a comprises a resonant signal and a command signal. As already described, the resonant attack signal 101a may lead to a noisy measurement signal causing a reading error. The additional command signal, which may be carried by the resonant signal, may inject commands manipulating the measurement signal in a controlled way. A maliciously influenced reading 102c of an acceleration or an angular velocity measurement signal may be a result of the manipulating commands. This may cause accidents of vehicles or devices using MEMS sensors, like accelerometers or gyroscopes.

In other words, the attack 101 may enable an attacker 140 to take control of sensor outputs using the idea of injecting resonant signals into the sensor. Besides causing a denial of service attack and consequently crashing vehicles, such as drones, it may even be possible for an attacker 140 to take fine grained control over an accelerometer's output, and thus to control a system which relies on these sensors. For example, injecting malicious sound signals into an Android smartphone's accelerometer may enable an attacker to take control of an app that drives a radio-controlled (RC) car.

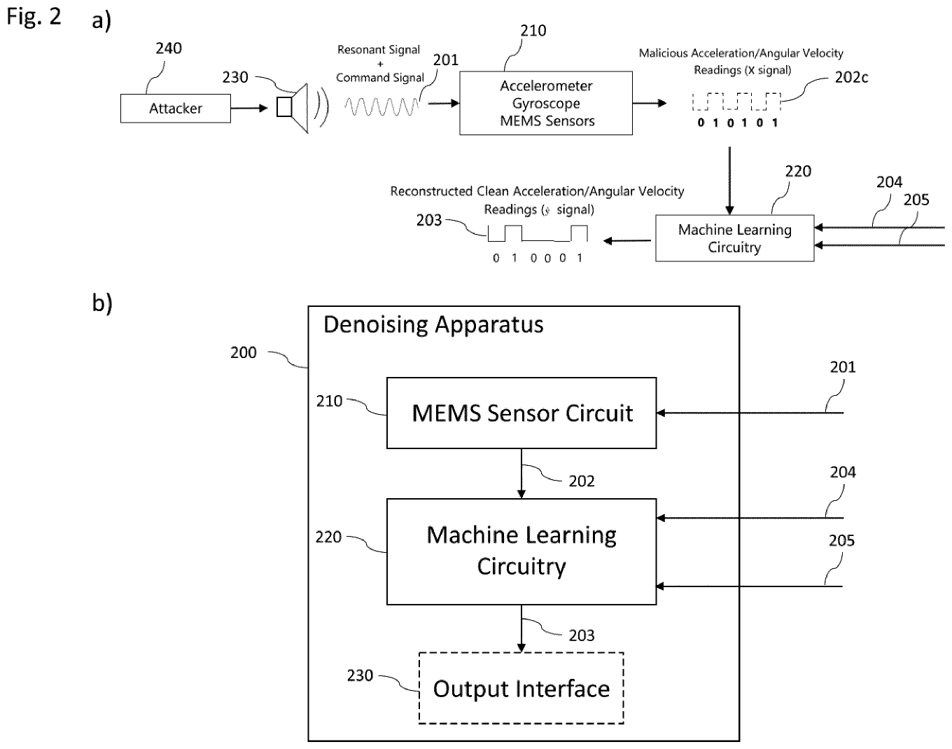

FIG. 2 a) illustrates an embodiment of the proposed solution to this problem by introducing a machine learning circuitry 220 to separate the useful signal component 202b from the attack signal component 202a of the manipulated measurement signal 202c in order to denoise the same. For denoising the noisy measurement signal generated by the MEMS sensor, the machine learning circuitry 220 may learn a denoising model mapping a noisy measurement signal x to a reconstructed useful signal ŷ 203 according to a model function f(x)→ŷ.

The proposed denoising concept is illustrated in FIG. 2 b) showing a denoising apparatus 200 according to an embodiment.

The denoising apparatus 200 comprises a MEMS sensor 210 configured to generate a measurement signal 202 in response to a physical quantity. In case of an attack the resulting malicious measurement signal 202c comprises a useful signal component 202b indicative of the physical quantity and an attack signal component 202a due to the attack on the MEMS sensor 210. The denoising apparatus 200 further comprises a machine learning circuitry 220 configured to estimate the useful signal component 202b based on the (noisy) measurement signal 202c. For that purpose, a machine learning algorithm, executed by the machine learning circuitry 220, is trained based on training signals comprising known useful signal components 204 and known attack signal components 205.

In order to mitigate manipulations of the measurements signal generated by the MEMS sensor circuit 210, the machine learning circuitry 220 may learn the model function for denoising the noisy measurement signal of an attacked MEMS sensor. Suitable models for denoising may be obtained by recurrent neural networks (RNNs) or recurrent denoising autoencoders (RDAEs). The architecture of a RDAE is based on recurrent neural networks (RNNs) and denoising autoencoders (DAEs).

In general, there are two major types of neural networks, the feedforward and the recurrent networks. In feedforward networks, the activation is directed from the input units to the output units. Typically, activation is fed forward from input to output through hidden layers (e.g. Multi-Layer Perceptron, MLP). Mathematically, they implement static input-output map-pings/functions. By contrast, a recurrent neural network (RNN) has (at least one) cyclic path of synaptic connections. Mathematically, RNNs implement dynamical systems.

The elementary building blocks of a RNN are neurons/perceptrons (units) connected by synaptic links (connections) whose synaptic strength is coded by one or more weights. Typically, input units, internal (or hidden) units, and output units are distinguished. At a given time, a unit has an activation.

There are many types of formal RNN models. Discrete-time models are mathematically generated as maps iterated over discrete time steps. Continuous-time models are defined through differential equations whose solutions are defined over a continuous time. Especially for purposes of biological modeling, continuous dynamical models can be quite involved and describe activation signals on the level of individual action potentials. Often the model incorporates a specification of a spatial topology, most often of a 2D surface where units are locally connected in retina-like structures.

The training of autoencoder neural networks is performed by use of known training data sets, like for example known noisy data (image or sounds) and their original or useful signal; this kind of training is called supervised training. In other words, a training data set comprises a tuple of signals (x, y), where x is the input data, e.g. a known noisy measurement signal. y is a known output corresponding to measurement signal without any noise. Specifically, x comprises instances of “malicious” sequences, such as instances with resonant frequencies (e.g. attack signal component), as well as sequences of “useful” instances representing a useful signal component; y comprises the measurement signal in response to a measured physical entity for each instance of the x signal and thus it might be free of any noise. The result of the training phase is the model ƒ which maps the input signal x to the signal y. The model function may be defined as

ŷ=ƒ(x),

where ŷ is a prediction of y. The error of the output can be measured via a loss function L, such as squared error or cross-entropy loss

L(ŷ,y)=∥ŷ−y∥²,

where ∥·∥ is the L² norm of the two vectors y and ŷ. The goal of the training algorithm is to look for weights w which minimize this error.

Due to the fact that x contains both a malicious instance (attack signal component) and a useful instance (useful signal component) there are two cases for the model ƒ. If an instance of the measurement signal x is equal to an instance of the useful signal y, then the model ƒ is the identity function. If an instance of the measurement signal x is a malicious instance, then the model ƒ is a function reconstructing the respective instance of the useful signal y.

An autoencoder neural network which attempts to reconstruct a useful signal (clean version of its own noisy input) is known as a denoising autoencoder.

For example, a single hidden layer denoising autoencoder outputs its prediction ŷ. The function ƒ of the denoising encoder is described as previously defined ŷ=ƒ(x). Autoencoders take an input vector xϵ[0,1] and map it to a hidden compressed representation hϵ[0,1] as follows:

h=ƒ_{θ}(x)=σ(Wx+b).

ƒ_{θ} is parameterized by θ={W,b}, where W is a weight matrix and b is a bias vector. This procedure is also known as the encoder phase. σ is an activation function which is used to trigger neuron/perceptron outputs. There are several examples of these functions, such as: Rectified Linear Unit (ReLU) and variations, Sigmoid, Gaussian, Hyperbolic Tangent, etc. The choice of them dependents on the domain problem.

The compressed representation h is then mapped back to a reconstructed vector ŷ, as follows

ŷ=g_{θ′}(x)=σ(W′h+b′)

g_{θ′} is a similar model function as ƒ_{θ} with the difference that it is used for the decoder phase. It is parameterized by θ′={W′,b′}. This procedure is also known as the decoder phase, and this architecture is a special case of encoder-decoder neural networks.

Each training instance x(i) is thus mapped to a corresponding h(i) and a reconstruction ŷ(i) in an interative manner, i, from 0 to n, where n is the data set size or batch size. The parameters of this models are optimized to minimize the average reconstruction error via the loss function L as follows:

$$θ , {θ}^{′} = argmin \frac{1}{n} {\sum }_{i = 1}^{n} L ( \hat{y} ( i ) , y ( i ) ) ,$$

where arg min is a function to determine the point at which a function is at its minimum. The previous mentioned denoising autoencoder (DAE) assumes that only short context regions are needed to reconstruct a clean signal from a noisy signal and this may be a poor assumption which may lead to reconstruction errors. To increase the model accuracy recurrent layers may be added to the denoising autoencoder (DAE). These recurrent layers can memorize long-term sequence interdependences. A recurrent network computes its outputs using both the input signal sample for the current time step xₜ and the hidden representation from the previous time steps xₜ₋₁. Therefore, it is possible to conceptually combine layers of recurrent neural networks with an autoencoder by adding recurrent layers as follows:

h_{θ}(xₜ)=σ(Wxₜ+b+Uh(xₜ₋₁)),

where h_{θ} is based on h=ƒ_{θ}(x)=σ(Wx+b). The result of the previous time step h(xₜ₋₁₎ is connected to the current step xₜ via the weight matrix U connecting hidden units for the current time step to hidden unit activations in the previous time step. More recursive layers could be connected by adding more previous time steps as follows

h_{θ}(xₜ)=σ(Wxₜ+b+U₁h(xₜ₋₁)+U₂h(xₜ₋₂)+ . . . +Uₙh(xₜ₋ₙ)).

This setup constitutes a deep recurrent denoising autoencoder.

In short, a recurrent denoising autoencoder is based on the structure of an autoencoder comprising an encoder portion and a decoder portion. In contrary to basic autoencoders, the recurrent denoising autoencoders comprise recurrent layers as hidden layers in their encoder portion and decoder portions instead of feed forward layers.

One benefit of using a recurrent denoising autoencoder neural network instead of a regular denoising autoencoder neural network is to address the problem of high correlation between the MEMS sensor's measurement signal and the noise injected by the sound (spoof) attack. Thus, the recurrent denoising autoencoder neural network is more capable to separate them by including the time dimension.

Recurrent Denoising Autoencoders (RDAEs) may be used to remove the attack signal component from the MEMS sensor circuit's noisy measurement signal, caused by the attack. The command signal of the attack may try to take advantage over a device where the MEMS sensor circuit is implemented in. The training of a model function being used may comprise learning the useful signal component from the MEMS sensor circuit's noisy measurement signal. With a given the noisy measurement signal x, the RDAE neural network may output a prediction ŷ=f(x) of the useful signal, the clean y. Therefore, to train the model, it may be necessary to provide the noisy measurement signal as features, x, and the useful signal component, y, as the target signal to be approximated by the training process.

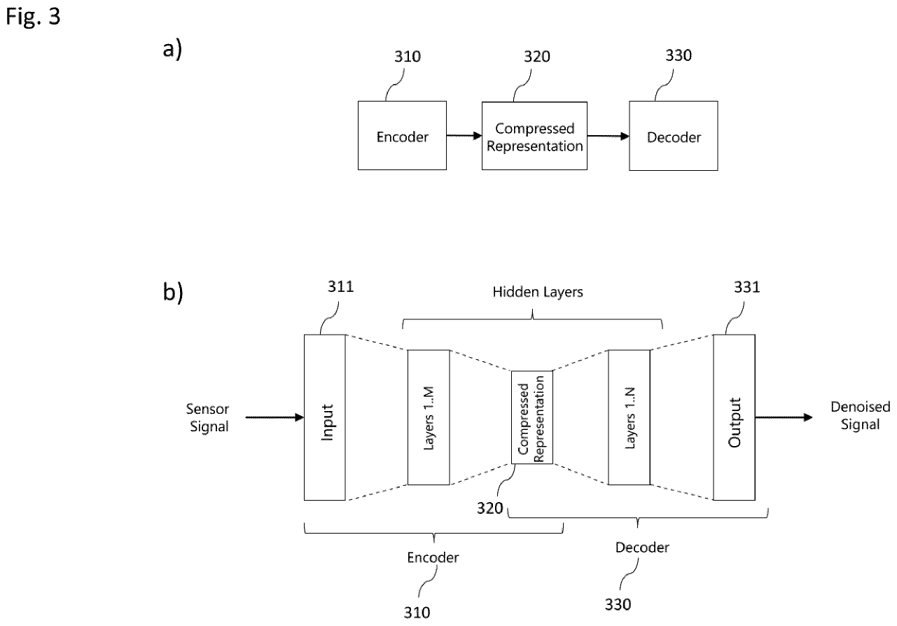

A recurrent denoising autoencoder is a special type of recurrent neural networks. The logical structure of an RDAE network is shown in FIG. 3 a) and b). The encoder 310 is a set of layers where the model learns how to reduce the input dimensions and compress the input into a compressed representation 320. It can be made of a stack of RNN layers (i.e., LSTM or GRU) and spatial layers. The decoder 330 is a set of layers in which the model learns how to reconstruct the data from a compressed representation 320 and it is set up symmetrically in relation to the encoder 310, however it is also possible to construct an asymmetric structure. FIG. 3 b) also implies that the network may have multiple hidden layers, and thus the network is also known as Deep Neural Network. That characteristic increases the degree of freedom of the learnt model and allows models to learn different types of nonlinear signals, and thus may increase the accuracy of the prediction of the useful signal.

Embodiments of the denoising apparatus 200 may be used to protect manned or unmanned vehicles from attacks. An example of an unmanned vehicle is an unmanned aerial vehicle, also commonly referred to as a “drone”. Here, one or more MEMS sensors may be used to deliver sensor signals on which basis the drone may be controlled. An embodiment of the machine learning circuitry 220 may be used to free such sensor signals from undesired attack signal components.

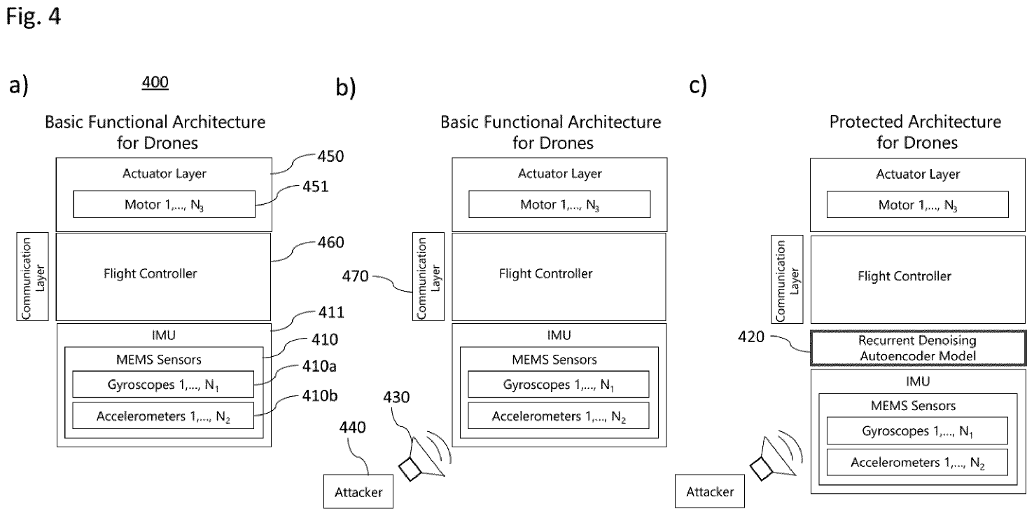

As illustrated in FIG. 4 a), a drone 400 may comprise an actuation layer 450, a flight controller 460, a communication layer 470, and an inertial measurement unit (IMU) 411. The actuator layer 450 may comprise motors 451 for driving the rotors. The IMU 411 may comprise MEMS sensors 410, in particular, gyroscopes 410a and accelerometers 410b.

In a normal operation scenario, users may send commands to a drone 400 via remote control. For example, a command to decrease the drone's altitude may be sent. The drone's communication layer 470 receives the command and sends it to the flight controller 460 which computes the new altitude based on the information from the IMU 411 and drives the motors 451 accordingly. The drone has its altitude decreased as expected.

In an attacker scenario, as illustrated in FIG. 4 b), an attacker 440 may use a computer equipped with a powerful sound source 430 to send a sound (spoof) attack comprising resonant signals and command signals. These resonant signals may cause the gyroscopes 410a and the accelerometers 410b to vibrate. Due to the vibration of these MEMS sensors, the measurement signals of the MEMS sensors 410 may become noisy and may lead to a reading error. Further, the command signals of the attack may manipulate the measurement signal of the MEMS sensors 410 in a way that the drone 400 is controlled by the attacker 440 and may crash.

In a protected scenario, as shown in FIG. 4 c), resonant frequencies which would cause unexpected behaviors to drones may be filtered out by use of a Recurrent Denoising Autoencoder Model 420 denoising the noisy measurement signal generated by the MEMS sensor. The filtered output for a given input sequence from sensors may be predicted and may deliver the result to the flight controller 460 of the drone. Depending on the drone architecture, it could be placed inside the Flight Controller 460, IMU 411 or be a dedicated device.

Further examples for vehicles comprising a denoising apparatus including a machine learning circuitry may be vehicles for military use like tanks, SUVs, helicopters, jets, submarines, etc. controlled either by a pilot or user inside the vehicle or in a command center via remote control (unmanned vehicles).

Furthermore, vehicles like cars, trucks, busses, SUVs, airplanes, helicopters, ships etc. may comprise a denoising apparatus including MEMS sensors.

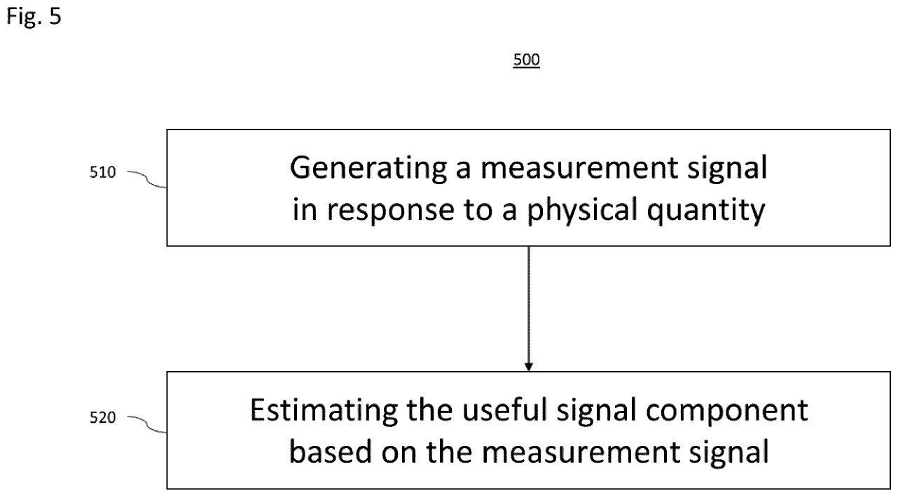

In order to summarize the above aspects on denoising noisy measurement signals, FIG. 5 further illustrates a flowchart of a method 500 for denoising a MEMS sensor's measurement signal. The method comprises generating 510 a measurement signal in response to a physical quantity. The measurement signal comprises a useful signal component indicative of the acceleration or angular velocity and an attack signal component due to an attack on the MEMS sensor circuit. The denoising method 500 further comprises estimating 520 the useful signal component based on the measurement signal. The machine learning circuitry may be trained based on training signals including known useful signal components and known attack signal components.

By estimating the useful signal component of the noisy measurements signal generated by the MEMS sensor circuit via machine learning, the disturbing attack signal component may be removed from the noisy measurement signal of the MEMS sensor circuit. In this way, only the useful signal may be forwarded, and a manipulation of the measurement signal generated by the MEMS sensor circuit may successfully be avoided.

The concept of the present disclosure can be deployed in an embedded platform in which the MEMS sensor output is not reliable. Therefore, the recommended way to detect it in a third-party product is applying technical analysis procedures, for example, reverse engineering techniques.

Note that the present technology can also be configured as described below.

(1) A denoising apparatus comprises a Micro-Electro-Mechanical System, MEMS, sensor circuit, configured to generate a measurement signal in response to a physical quantity. The measurement signal comprises a useful signal component indicative of the physical quantity and an attack signal component due to an attack on the MEMS sensor circuit.

The denoising apparatus further comprises a machine learning circuitry configured to estimate the useful signal component based on the measurement signal, the machine learning circuitry being trained based on training signals comprising known useful signal components and known attack signal components.

(2) The apparatus of (1), wherein the attack signal component comprises one or more signals generated by the MEMS sensor circuit in response to stimulating the MEMS sensor circuit with one or more stimuli at the MEMS sensor circuit's resonant frequency.

(3) The apparatus of any one of (1) to (2), wherein the attack signal component results from a sound attack.

(4) The apparatus of any one of (1) to (3), wherein the MEMS sensor circuit comprises at least one of a gyroscope circuit and an accelerometer circuit.

(5) The apparatus of any one of (1) to (4), wherein the machine learning circuitry comprises a neural network.

(6) The apparatus of (5), wherein the neural network comprises a recurrent neural network or a recurrent denoising autoencoder.

(7) The apparatus of (5) or (6), wherein the neural network comprises a Long Short-Term Memory, LSTM, recurrent neural network or a Gated Recurrent Unit, GRU, recurrent neural network.

(8) The apparatus of any one of (5) to (7), wherein the neural network comprises an encoder portion, and a decoder portion, wherein the encoder portion comprises an input layer for receiving the measurement signal and a set of hidden layers for compressing the input data to low dimensional data, wherein the decoder portion comprises a set of hidden layers for reconstructing the compressed low dimensional data and an output layer for outputting the estimated useful signal component, wherein each single layer comprises a matrix comprising a plurality of weights being a basis for compressing the input data in the encoder portion and reconstructing the compressed data in the decoder portion, and wherein the set of hidden layers of each the encoder portion and the decoder portion comprise multiple hidden layers, forming a deep recurrent neural network or a deep recurrent denoising autoencoder.

(9) The apparatus of any one of (1) to (8), further configured to forward the estimated the useful signal component as a control signal for controlling one or more devices.

(10) An unmanned aerial vehicle comprising the apparatus of any one of (1) to (9).

(11) A denoising method, comprising: generating, by a MEMS sensor circuit, a measurement signal in response to a physical quantity, wherein the measurement signal comprises a useful signal component indicative of the physical quantity and an attack signal component due to an attack on the MEMS sensor circuit; estimating, by a machine learning circuitry, the useful signal component based on the measurement signal, the machine learning circuitry being trained based on training signals comprising known useful signal components and known attack signal components.

(12) An apparatus, comprising: a MEMS sensor circuit configured to generate a measurement signal in response to a physical quantity, wherein the measurement signal comprises a useful signal component indicative of the physical quantity and an attack signal component due to an attack on the MEMS sensor circuit; a digital signal processor configured to estimate the useful signal component by eliminating the attack signal component from the measurement signal.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A denoising apparatus, comprising:
a Micro-Electro-Mechanical System, MEMS, sensor circuit, configured to generate a measurement signal in response to a physical quantity, wherein the measurement signal comprises a useful signal component indicative of the physical quantity and an attack signal component due to an attack on the MEMS sensor circuit;
a machine learning circuitry configured to estimate the useful signal component based on the measurement signal, the machine learning circuitry being trained based on training signals comprising known useful signal components and known attack signal components.

2. The apparatus of claim 1, wherein the attack signal component comprises one or more signals generated by the MEMS sensor circuit in response to stimulating the MEMS sensor circuit with one or more stimuli at the MEMS sensor circuit's resonant frequency.

3. The apparatus of claim 1, wherein the attack signal component results from a sound attack.

4. The apparatus of claim 1, wherein the MEMS sensor circuit comprises at least one of a gyroscope circuit and an accelerometer circuit.

5. The apparatus of claim 1, wherein the machine learning circuitry comprises a neural network.

6. The apparatus of claim 5, wherein the neural network comprises a recurrent neural network or a recurrent denoising autoencoder.

7. The apparatus of claim 5, wherein the neural network comprises a Long Short-Term Memory, LSTM, recurrent neural network or a Gated Recurrent Unit, GRU, recurrent neural network.

8. The apparatus of claim 5, wherein
the neural network comprises an encoder portion, and a decoder portion, wherein
the encoder portion comprises an input layer for receiving the measurement signal and a set of hidden layers for compressing the input data to low dimensional data, wherein
the decoder portion comprises a set of hidden layers for reconstructing the compressed low dimensional data and an output layer for outputting the estimated useful signal component, wherein
each single layer comprises a matrix comprising a plurality of weights being a basis for compressing the input data in the encoder portion and reconstructing the compressed data in the decoder portion, and wherein
the set of hidden layers of each the encoder portion and the decoder portion comprise multiple hidden layers, forming a deep recurrent neural network or a deep recurrent denoising autoencoder.

9. The apparatus of claim 1, further configured to forward the estimated the useful signal component as a control signal for controlling one or more devices.

10. An unmanned aerial vehicle comprising the apparatus of claim 1.

11. A denoising method, comprising:
generating, by a MEMS sensor circuit, a measurement signal in response to a physical quantity, wherein the measurement signal comprises a useful signal component indicative of the physical quantity and an attack signal component due to an attack on the MEMS sensor circuit; and
estimating, by a machine learning circuitry, the useful signal component based on the measurement signal, the machine learning circuitry being trained based on training signals comprising known useful signal components and known attack signal components.

12. An apparatus, comprising:
a MEMS sensor circuit configured to generate a measurement signal in response to a physical quantity, wherein the measurement signal comprises a useful signal component indicative of the physical quantity and an attack signal component due to an attack on the MEMS sensor circuit;
a digital signal processor configured to estimate the useful signal component by eliminating the attack signal component from the measurement signal.
